(19) United States
(12) Patent Application Publication
(10) Pub. No.: US 2018/0115624 A1
(43) Pub. Date: Apr. 26, 2018

(54) METHODS AND DEVICES FOR ENHANCING PRIVACY OF USERS OF A CLOUD-BASED SERVICE

(71) Applicant: SNIPS, Paris (FR)

(72) Inventor: Mathieu POUMEYROL, PARIS (FR)

(21) Appl. No.: 15/791,309

(22) Filed: Oct. 23, 2017

(30) Foreign Application Priority Data
Oct. 24, 2016 (EP) 16195285.8

(51) Int. Cl. H04L 29/08; H04L 29/06; G06F 21/62

(52) U.S. Cl. CPC H04L 67/2814; H04L 63/0428; G06F 21/602; G06F 21/6245; H04L 63/0407

(57) ABSTRACT

The described technology generally relates to methods and devices for enhancing privacy of users of a cloud-based service. In one aspect, the methods and devices are adapted to be implemented by a proxy of a communication infrastructure for routing a query sent by a client using the communication infrastructure to at least two servers of a service provider system for processing the query. The routing may involve receiving the query comprising private data encrypted so that only the at least one server can access the private data, retrieving an address of the client in the communication infrastructure and storing the address, and sending the query to the at least one server, using an address of the proxy in the communication infrastructure as a source address.

### CROSS-REFERENCE TO RELATED APPLICATION(S)

This patent application claims the benefit under 35 U.S.C. § 119 of European Application No. 16195285.8 filed on Oct. 24, 2016, which is hereby incorporated by reference in its entirety.

### TECHNICAL FIELD

The described technology generally relates to methods and devices for enhancing privacy of users of a cloud-based service.

### BACKGROUND

In a typical client-server interaction, the client—i.e., the application software that runs on the user's terminal—sends a query to a server—i.e., the application software that is accessed remotely by the client, on behalf of the user, through the Internet. Then, the server analyses the query, handles domain-specific computation—which can be trivial or not—and returns a response comprising results related to the computation, to the originating client. Each time a query is sent, private data of the user may be exposed explicitly and/or implicitly. For instance, when a client sends a geo-localized search query, a location and a search string are sent to the server. If the client and the server use the TCP/IP protocols to transfer data, one critical private data that is provided implicitly by the client is its IP address, since the server needs it to return the response to the client. A usual practice on the server-side consists in logging IP addresses together with the corresponding query. Depending on the configuration of the server, the IP address is usually kept from minutes to days—for a given client. An attacker may be able to collect a history directly of user queries. Even if the IP address is not stored on the server, if an attacker has gained enough access to snoop passively on the requests received by the server, without being detected by the developer, he will be able to use the stored IP addresses as a weak client/user identifier and link together the queries to the user. To solve this specific problem, various capabilities for query anonymization proposed to users willing to mask their identity while using Internet services are known. However, this type of solutions is not adapted to be integrated within the infrastructure of a developer—i.e., an organization that provides client software for the user's terminals and runs the servers providing a specific service. Consequently, anonymization capabilities, adapted to be used by developers willing to enforce globally the same level of anonymization, for all of its users, as this type of known user-centric solutions, are still to be offered.

### SUMMARY

In the context of a cloud infrastructure, a cloud provider designates an organization that lends infrastructure services to developers to host. Referring now to FIG. 1 (PRIOR ART), in a cloud environment 100, the developer has provisioned, from a cloud provider, four web service servers 120, coupled to two database servers 160, and assumes full control over them. Ready-to-use proxies—also usually called Load Balancers 40; 50—are used by the could provider to front all queries from clients 110 to web service providers 120 and the database servers 160. By using a network configuration the developer has no access to, the cloud provider can provide a fixed DNS address or IP address to the developer, the latter using in turn said address for coding or configuring the clients 110. The developer has very little control or knowledge of how the load balancer are implemented and managed. Load balancers operates in two modes:

a Level 4 mode (also called layer 4 mode), where routing decisions are taken based on protocols belonging to the fourth layer of the OSI model—typically, IPs and TCP or UDP;

a Level 7 mode (also called layer 7 mode), where routing decisions are taken based on protocols belonging to the seventh layer of the OSI model—typically, HTTP, FTP, SMTP, DNS protocols.

Most of the time, level 4 mode is used for internal server to server traffic, while level 7 mode is used to accept queries from the clients. In the example of FIG. 1, the webservers 120 are coupled to two database server 160 by a level 4 load balancer 50, while the clients are coupled to the webservers 120 through a level 7 load balancer 40. By using a level 7 load balancer 40 as fronthead, the cloud provider handles the eventual SSL termination between the clients 110 and the load balancer 40: the cloud provider can thus alter the query before sending it to the actual server 120. The purpose of this alteration is specifically to transfer the client IP to the application backend. Developers expect the server to be able to use and track the client IP when privacy is not a first-class concern. In this configuration, a typical request cycle would be as follows:

A client 110 issues a query to be process by the servers 120, 160. The client knows the IP address of the level 7 load balancer 40 and send the query to it, typically using the HTTPS protocol, exposing its own IP to the level 7 load balancer 40.

The level 7 load balancer 40 receives and analyses the query, chooses one of the Web Service Servers 120 and forwards the query to it, using the IP address of the level 7 load balancer 40 instead of the client's IP address. In order to allow the Web Service Server 120 to make use of the client IP, the level 7 load balancer 40 also alters the query and adds the client's IP address IP as metadata.

The chosen Web Service Servers 120 analyses the request and interacts with the database servers 160 to compute a response, through the Level 4 load balancer 50.

As a consequence, the Web Service Server 120 has access to the client IP address, since the level 7 load balancer 40 alters the query and adds the client's IP address IP as metadata. Consequently, known cloud based infrastructure does not provides robust solutions, adapted to be used by developers, to protect sensible private data of clients, since clients' IP addresses are sent to the web service server 120.

It is therefore still desirable to provide methods and devices for enhancing privacy of users of a cloud-based service, adapted to be offered by a developer.

According to the described technology, a user is a person that installs and/or interacts with an application, on a terminal—for example, a smartphone—in order to use a service.

According to the described technology, a client is a software application, adapted to be executed on the user terminal, to provide access to a service.

According to the described technology, a server is a software application, adapted to be accessed remotely by a client, on behalf of the user, through the Internet for example.

According to the described technology, a developer is an organization that provides a software application of a client, for example for a user's smartphone, and runs the corresponding software application of the server.

According to the described technology, a cloud provider is an organization that lends infrastructure services to the developer to host the software application of the server.

To that end, according to a first aspect of this disclosure, the described technology concerns a method, adapted to be implemented by a proxy of a communication infrastructure, for routing a query QsecAc sent by a client using the communication infrastructure, to at least two servers of a service provider system for processing said query. The method may comprise the following steps:

receiving the query comprising private data encrypted so that only the at least one server can access the private data;

retrieving an address Ac of the client in the communication infrastructure and storing said address;

sending the query to one of the at least two servers, using an address of the proxy in the communication infrastructure as a source address, wherein the one of the at least two servers only has access to the address of the proxy, and not to the address Ac of the client.

In particular, the communication infrastructure may be a cloud infrastructure of a cloud provider. The proxy can be hosted in the cloud infrastructure. The service provider system can belong to a developer. Private data are related to the user of the client, and may be exposed explicitly and/or implicitly in the query. Private data are, for instance, a location and a search in the query. The whole content of the query can also be totally encrypted, and not only the private data, so that only the at least one server can access the private data.

The described technology allows enhancing privacy of users of a cloud-based service, offered by a developer, by ensuring that the address Ac of the client—for example, its IP address, never reaches the at least one server. In fact, since the query is sent by the proxy to the at least one server, using the address of the proxy in the communication infrastructure as a source address, the at least one server only has access to the address of the proxy, and not to the address Ac of the client. In other words, the client address is removed from the query by the proxy. Moreover, the proxy cannot access to the content of the encrypted private data. The described technology prevents accidental or malignant address—base tracking on the server, since that the address Ac of the client actually never reaches the server.

As a consequence, the described technology addresses specifically the case where a developer chooses the following set of constraints, to enforce a higher than usual protection of the user privacy:

the loss of user privacy incurred by one given query drowned in the sum of all queries for all users reaching the server at the same instant is acceptable; this would be akin to somebody speaking on its phone in a crowd, not caring that a few sentences can be overheard by strangers: the conversation is not private, but the anonymity provided by the crows is considered good enough;

the ability to link together several queries from a user on a given period of time is not acceptable, regardless this is achieved by tracking a user ID given explicitly in the query or by exploitation of the query and protocol metadata; with the same analogy, this would mean intruding on the overheard conversation by shadowing the phone user in the crowd.

The method may further comprise the following steps:

receiving, from the one of at least two servers, a response RsecApx to the query comprising private information, in which the private information is encrypted so that only the client can access the private information;

retrieving the address Ac of the client;

sending to the client, the response RsecAc to the query, using the address of the proxy as a source address.

The query may be sent to the at least one server using a transport level protocol and a secured application level protocol, provided by the communication infrastructure. The response RsecAc to the query may be sent to the client using a transport level protocol and a secured application level protocol, provided by the communication infrastructure. The service provider system may comprise at least two servers for processing said query, the query being sent to one of the at least two servers, depending on information extracted by the proxy from the transport level protocol provided by the communications infrastructure. The proxy can be in particular a fronthead load balancer operating in level 4 mode—where routing decisions are taken based on protocols belonging to the fourth layer of the OSI model, instead of the usual level 7 modes. The proxy hides physically the IP of the client from the servers. Moreover, the load balancer no longer holds the developer certificates: it cannot decrypt the query content. The server is physically isolated from the client address, totally preventing accidental or malignant IP tracking on the developer controlled system. The load balancer, controlled by the cloud provider knows the IP but cannot inspect their content. It only knows how to match the incoming connections—from the client—to the outgoing connections—to the servers. The servers, controlled by the developer, can decrypt and answer the queries, but does not know the originating client IP. We have moved for a situation where the cloud provider and the developer both have full information—IP and query content—to a situation where each party gets minimum information. A benefit of using the Load Balancer as described previously lies in its simplicity to implement and audit, and the absence of marginal cost as Load Balancer is something the developer would typically have to use anyway.

According to a second aspect of this disclosure, the described technology also relates to a computer program that can be downloaded from a communication network and/or stored on a non-transitory medium. This computer program comprises instructions for causing implementation of the method according to the first aspect of this disclosure, when said program is run by the processor.

According to a third aspect of this disclosure, the described technology also relates to an information storage system, storing a computer program comprising a set of instructions causing implementation of the method according to the first aspect of this disclosure, when the stored information is read from said information storage system and run by a processor.

According to a fourth aspect of this disclosure, the described technology also relates to a proxy of a communication infrastructure, adapted to route a query QsecAc sent by a client using the communication infrastructure, to at least two servers of a service provider system for processing said query. The proxy comprises:

a query receiver configured to receive the query comprising private data encrypted so that only the at least one server can access the private data;

a client address reader configured to retrieve an address of the client in the communication infrastructure and storing said address;

a query transmitter configured to send the query to one of the at least two servers, using an address of the proxy in the communication infrastructure as a source address, wherein the one of the at least two servers only has access to the address of the proxy, and not to the address Ac of the client.

The proxy may further comprise:

a response receiver configured to receive, from the one of the at least two servers, a response to the query comprising private information, in which the private information is encrypted so that only the client can access the private information;

the client address reader being configured to retrieve the address of the client;

a response transmitter configured to send to the client, the response to the query, using the address of the proxy as a source address.

The query transmitter configured to send the query to the one of the at least two servers, may be configured so as that the query is sent to the one of the at least servers using a transport level protocol and a secured application level protocol, provided by the communication infrastructure. The response transmitter configured to send to the client, the response to the query, may also be configured so as that the query is sent to the client using a transport level protocol and a secured application level protocol, provided by the communication infrastructure. The service provider system may comprise at least two servers for processing said query, and the query transmitter configured to send the query may be configured so as that the query is sent to one of the at least two servers, depending on information extracted by the proxy from the transport level protocol provided by the communications infrastructure.

### BRIEF DESCRIPTION OF THE DRAWINGS

The characteristics of the described technology will emerge more clearly from the following description, said description being made with reference to the accompanying drawings, amongst which:

FIG. 1 schematically represents a system according to the prior art;

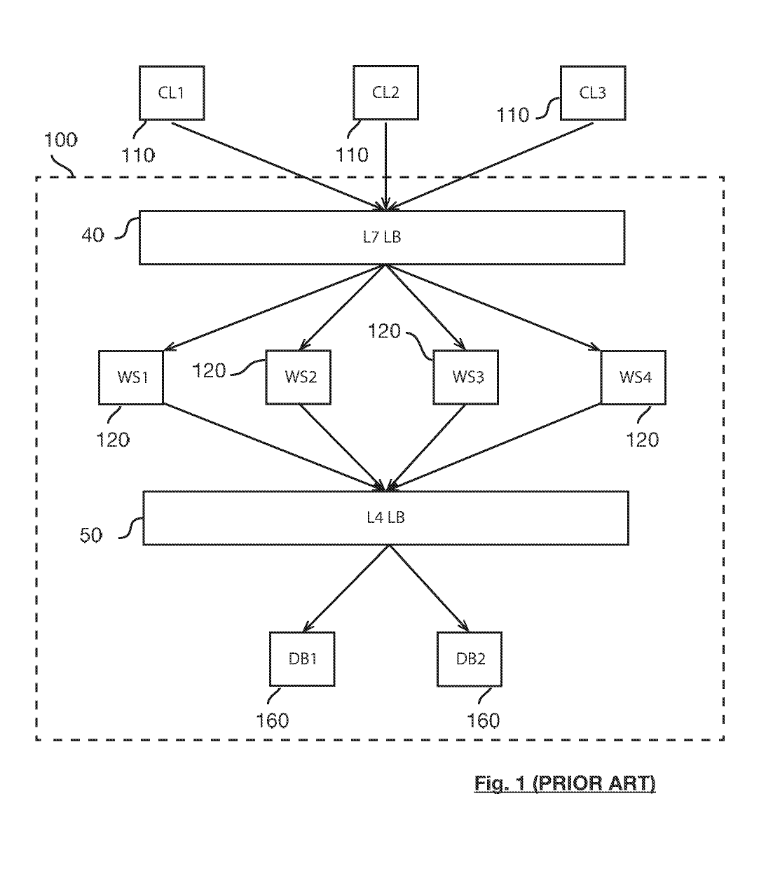

FIG. 2 schematically represents, by a schematic diagram, the steps of a method according to aspects of this disclosure for processing anonymously a query sent by a client to a server of a developer;

FIG. 3 schematically represents, by a schema, a system for processing anonymously a query sent by a client to a server of a developer, according to aspects of this disclosure.

### DETAILED DESCRIPTION

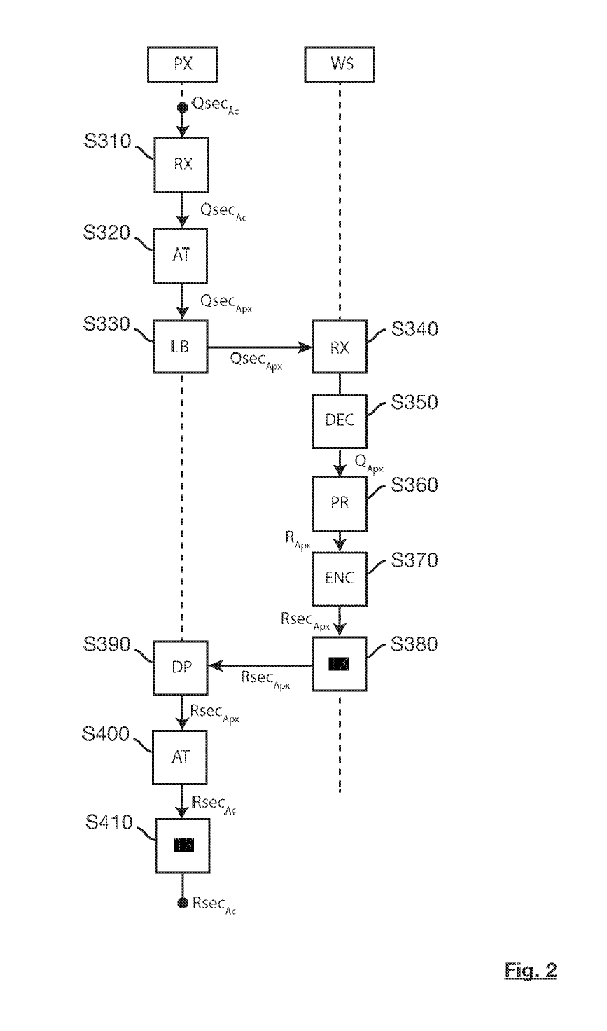

Any and all steps of the method described hereafter with regard to FIG. 2 may be implemented in software by execution of a set of instructions or program by a programmable computing machine, such as a Personal Computer (PC), a Digital Signal Processor (DSP) or a micro-controller; or else implemented in hardware by a machine or a dedicated component, such as an Field-Programmable Gate Array (FPGA) or an Application-Specific Integrated Circuit (ASIC).

FIG. 2 schematically represents a method according to the described technology for processing a query QsecAc sent by a client C to a server WS of a developer. The method allows in particular to enhance the privacy of the user of the client.

The query QsecAc is intended to be processed by at least one server WS and may comprise private data of the user. The query QsecAc is sent over a communication infrastructure. The communication infrastructure provides a query transmitter and a response transmitter configured to send and to route the query QsecAc to an address Aws related to the server WS and a response AsecAc back to an address Ac related to the client. More particularly, the communication infrastructure may provide a client-proxy communication unit configured to establish a communication channel between the client and a proxy, a proxy-server communication unit configured to establish a communication channel between the proxy and the server WS. The proxy PX comprises a proxy router configured to route information between the server WS and the client C. In the communication infrastructure, the client has an address Ac, the proxy an address Apx, and the server WS an address Aws.

The query QsecAc is sent encrypted by the client C, so as that only the server WS can decrypt and access to the content of the query QsecAc.

In an embodiment, the communication infrastructure implements the seven layers of the OSI model, and more particularly, offers a secured application level protocols for transferring information between the server WS and the client C. For example, the communication infrastructure can offer an HTTPS service. In this example, the query QsecAc may then be encrypted by the client C using the HTTPS services.

In a step S310, the proxy PX receives, from the client C, the encrypted query QsecIPc. Since the query has been encrypted by the client C, so as that only the server WS can decrypt and access to the content of the query QsecIPc, the proxy PX cannot access to the content of the query QsecIPc.

In a step S320, the proxy PX retrieves the address Ac of the client from the query QsecAc, store said address Ac, and replace the address Ac by its own address Apx in the query QsecAc. The proxy PX does not decrypt the query QsecAc.

In a step S330, the proxy PX send the query QsecAc to the server WS.

In an embodiment, the proxy PX is a load balancer configured to share received queries amongst a set of servers WS managed/provided by the developers, according for example to the actual load and/or availability of the set of servers WS. In an advantageous embodiment, the proxy PX is a load balancer configured in Level 4 mode—also called layer 4 mode, where routing decisions are taken based on protocols belonging to the fourth layer of the OSI model—typically, IPs and TCP or UDP. In this embodiment, during the step S330, the proxy PX send the query QsecAc to one server WS of the set of servers WS.

In a step S340, the server WS receives the query QsecAc. The server WS does not have access to the address AC of the client.

In a step S350, the server WS determines an unencrypted query QAc by decrypting the query QsecAc.

In a step S360, the server WS process the query QAc so as to determine a response RAC. To process the query QAc, the server WS can cooperate with others local or remote systems, such as database servers or other servers.

In a step S370, the server WS determine an encrypted response RsecAC by encrypting the response RAC, so as that only the client C can decrypt and access to the content of the encrypted response RsecAC.

In a step S380, the server WS send the encrypted response RsecAC to the proxy PX, using the address Apx received in the query QsecAc.

In a step S390, the proxy PX receives the encrypted response RsecAC.

In a step S400, the proxy PX retrieves the address Ac of the client, stored during the step S320, and replaces the address Apx in the encrypted response RsecAC by the address Ac of the client. The proxy PX does not decrypt the encrypted response RsecAC.

In a step S410, the proxy sends the encrypted response RsecAC to the client C.

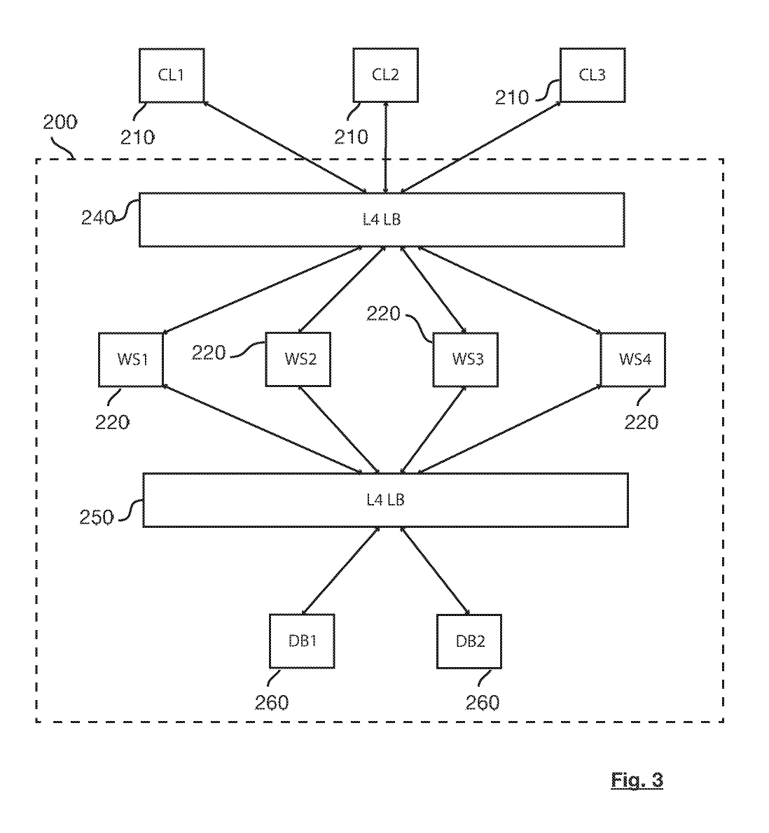

Now we refer to FIG. 3, representing schematically a system for processing anonymously a query sent by a client to a server of a developer, according to an embodiment of the described technology. The system is in particular adapted to implement the method according to the described technology, previously described and represented in FIG. 2. In this embodiment, the system is part of a cloud infrastructure 200 of a cloud provider. The developer has provisioned, from the cloud provider, four web service servers 220, coupled to two database servers 260, and assumes full control over them. A fronthead load balancer 240 is provided in the cloud infrastructure 200 by the cloud provider to front queries from clients 210 to web service servers 220. The fronthead load balancer 240 is adapted to route secure communications between the clients 210, and the web service servers 220. However, the fronthead load balancer 240 is not provided with a decrypting processing unit for decrypt data information, and in particular queries, exchange between the clients 210, and the web service servers 220. By configuration, the fronthead load balancer 240 is provided with an address reader configured to determining an address related to the client having sent a query. The fronthead load balancer 240 is also configured to have access to addresses of the web service servers 220.

Advantageously, the fronthead load balancer 240 may be configured so as to operate in Level 4 mode—also called layer 4 mode, where routing decisions are taken based on protocols belonging to the fourth layer of the OSI model—typically, IPs and TCP or UDP. In this embodiment, if clients 210 are configured to send queries, using an HTTPS tunnel handled by the developer, to the web service servers 220, the fronthead load balancer 240 in level 4 mode will be able to adequately route the queries received from the clients to the web service servers, but will not be capable of decrypt data comprised in the received query. In fact, in this configuration, the SSL terminations are located for one end in the client 210 having sent the query and for the other end in the web service server 220 receiving the query dispatched by the fronthead load balancer 240.

A back-end load balancer 250 may also be provided in the cloud infrastructure 200 by the cloud provider to dispatch queries from web service servers 220 to the database servers 260. Typically, the back-end load balancer 250 is configured so as to operate in Level 4 mode.

A typical scenario will now be described. One of the clients 210 issues a query to be processed by one of the servers 220. The client is configured to send the query to a service address—an IP address, for example—related to the services offered by the servers of the developer. The client sends the query to said service address using a cryptographic protocol, for example Transport Layer Security or Secure Sockets Layer, so as that only one of the web service servers 220 can access to the content of the query. Due to the network configuration of the cloud infrastructure, the fronthead load-balancer 240 receives the encrypted query. The fronthead load-balancer 240 extracts and stores the address of the client 210, for example an IP address—associated to the query. It is reminded that the fronthead load-balancer 240 cannot decrypt the query, and consequently cannot access to the content of said query. The fronthead load-balancer 240 chooses the processing servers 220 amongst all the Web Service Servers 220 of the developers. The fronthead server sends the encrypted query to the processing server 220, using its own address—for example, an IP address of the fronthead load balancer—instead of the client's address. The processing server 220 decrypts and analyses the query. The processing server may interact with other web services servers and/or the database servers 160 to compute a response. The processing server 220 sends the answer back to the address of the sender from which it receives the query—i.e., the fronthead load balancer, using a cryptographic protocol, for example Transport Layer Security or Secure Sockets Layer, so as that only one of the client 220 having sent the query can access to the content of the answer. The fronthead load-balancer 240 receives the encrypted answer. The fronthead load-balancer 250 loads the stored address of the client 210, and sends the answer back to this stored address of the client 210. It is reminded that the fronthead load-balancer 240 cannot decrypt the answer, and consequently cannot access to the content of said answer.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

What is claimed is:

1. A method, adapted to be implemented by a proxy of a communication infrastructure, for routing a query sent by a client using the communication infrastructure, to at least two servers of a service provider system for processing said query, the method comprising:
receiving the query comprising private data encrypted so that only the at least one server can access the private data;
retrieving an address of the client in the communication infrastructure and storing said address; and
sending the query to one of the at least two servers, using an address of the proxy in the communication infrastructure as a source address, wherein the one of the at least two servers only has access to the address of the proxy, and not to the address of the client.

2. The method of claim 1, further comprising:
receiving, from the one of at least two servers, a response to the query comprising private information, in which the private information is encrypted so that only the client can access the private information;
retrieving the address of the client;
sending to the client, the response to the query, using the address of the proxy as a source address.

3. The method of claim 1, wherein the query is sent to the at least one server using a transport level protocol and a secured application level protocol, provided by the communication infrastructure.

4. The method of claim 2, wherein the response to the query is sent to the client using a transport level protocol and a secured application level protocol, provided by the communication infrastructure.

5. The method of claim 3, wherein the query is sent to one of the at least two servers, depending on information extracted by the proxy from the transport level protocol provided by the communications infrastructure.

6. A non-transitory computer readable storage medium comprising instructions, which when executed by a processor, cause the processor to implement the method of claim 1.

7. A proxy of a communication infrastructure, adapted to route a query sent by a client using the communication infrastructure, to at least two servers of a service provider system for processing said query, the proxy comprising:
a query receiver configured to receive the query comprising private data encrypted so that only the at least one server can access the private data;
a client address reader configured to retrieve an address of the client in the communication infrastructure and storing said address; and
a query transmitter configured to send the query to one of the at least two servers, using an address of the proxy in the communication infrastructure as a source address, wherein the one of the at least two servers only has access to the address of the proxy, and not to the address of the client.

8. The proxy of claim 7, further comprising:
a response receiver configured to receive, from the one of the at least two servers, a response to the query comprising private information, in which the private information is encrypted so that only the client can access the private information, the client address reader being configured to retrieve the address of the client; and
a response transmitter configured to send to the client, the response to the query, using the address of the proxy as a source address.

9. The proxy of claim 7, wherein the query transmitter is further configured to send the query to the one of the at least two servers, are configured so as that the query is sent to the one of the at least two servers using a transport level protocol and a secured application level protocol, provided by the communication infrastructure.

10. The proxy of claim 8, wherein the response transmitter configured to send to the client, the response to the query, are configured so as that the query is sent to the client using a transport level protocol and a secured application level protocol, provided by the communication infrastructure.

11. The proxy of claim 9, wherein the service provider system comprises at least two servers for processing said query, and wherein the query transmitter configured to send the query being configured so as that the query is sent to one of the at least two servers, depending on information extracted by the proxy from the transport level protocol provided by the communications infrastructure.
